(19) United States
(12) Patent Application Publication
(10) Pub. No.: US 2011/0121090 A1
(43) Pub. Date: May 26, 2011

(54) Polygonal Wheel with Radial Projections

(76) Inventor: Dan Price, Price, ND (US)

(21) Appl. No.: 12/625,221

(22) Filed: Nov. 24, 2009

(51) Int. Cl. A01G 25/09; B05B 3/18; B60B 15/00

(52) U.S. Cl. 239/1; 239/735; 301/43

(57) ABSTRACT

Embodiments of the present invention provide a wheel for an agricultural irrigation system that permits movement of the irrigation system through muddy, slippery fields without leaving significant wheel ruts in the field and without requiring regular tire maintenance. In a first aspect, the present invention provides a regular polygonal wheel for use in an agricultural irrigation system. The wheel can include a central hub defining a central bore that is configured to mate with a wheel stud of the agricultural irrigation system. The wheel can include an outer circumferential portion that is configured to contact a surface on which the wheel is rolling. The circumferential portion can include a plurality of flat rectangular plates connected together to form a regular polygon. Each plate can have inner and outer opposed major surfaces, along with first and second opposed edges and third and fourth opposed edges. Each plate can be oriented such that its inner and outer major surfaces are perpendicular to the wheel's radius. Each plate can have its first edge connected to the second edge of another of the plurality of plates to form an interior angle. Each plate can have the first edge of yet another of the plurality of plates connected to its second edge to form the interior angle. The interior angle multiplied by the number of plates equals 360 degrees. The wheel can include a plurality of spokes connecting the central hub and the outer circumferential portion.

### BACKGROUND

Irrigation systems for agricultural use typically include wheels which allow the systems to move to various locations in the fields. After a sufficient amount of water is supplied to one area of the field, the irrigation system can be moved to a new location by rolling on the wheels. However, after water is supplied to the field in one area, the ground becomes soft and muddy, making it difficult to move the irrigation system. Typically, mobile irrigation systems include round wheels such as tires, but these tend to spin in place and can have difficulty moving forward when the ground becomes muddy.

The wheels of irrigation systems typically include round rubber tires, which are driven by a gear box to traverse the field. In order to improve fraction, the tires may include a tread which is meant to grip the ground. However, because the ground becomes very wet during the irrigation process, and because the irrigation systems are heavy, the tread on the tires is often not sufficient to prevent the tires from spinning. As a result, the round wheels can spin in the ground, forming deep ruts and damaging the crops. As the wheels continue to spin and dig deeper into the ground, the system can become stuck and unable to advance. Existing tires are therefore often inadequate for moving irrigation systems around fields after they have been watered.

### SUMMARY

Embodiments of the present invention provide a wheel for an agricultural irrigation system that permits movement of the irrigation system through muddy, slippery fields without leaving significant wheel ruts in the field and without requiring regular tire maintenance. In a first aspect, the present invention provides a regular polygonal wheel for use in an agricultural irrigation system. The wheel can include a central hub defining a central bore that is configured to mate with a wheel stud of the agricultural irrigation system. The wheel can include an outer circumferential portion that is configured to contact a surface on which the wheel is rolling. The circumferential portion can include a plurality of flat rectangular plates connected together to form a regular polygon. Each plate can have inner and outer opposed major surfaces, along with first and second opposed edges and third and fourth opposed edges. Each plate can be oriented such that its inner and outer major surfaces are perpendicular to the wheel's radius. Each plate can have its first edge connected to the second edge of another of the plurality of plates to form an interior angle. Each plate can have the first edge of yet another of the plurality of plates connected to its second edge to form the interior angle. The interior angle multiplied by the number of plates equals 360 degrees. The wheel can include a plurality of spokes connecting the central hub and the outer circumferential portion.

In some embodiments, the wheel can include a plurality of radial projections extending radially outward from the outer major surface of one or more of the plates of the outer circumferential portion. The radial projections can be configured to contact the surface on which the wheel is rolling. Each radial projection can include a V-shaped projection (e.g., a piece of angle iron). The V-shaped projection can have first and second rectangular sides with inner edges connected to the outer major surface of the corresponding plate and outer edges that connect with one another to form a V. The V-shaped projection can be oriented in parallel with the first and second edges of its corresponding plate. Each V-shaped projection can extend from the third edge to the fourth edge of the corresponding plate. The first and second rectangular sides of the V-shaped projection can form an interior projection angle which is less than the interior angle.

Wheel embodiments according to the first aspect of the present invention can include one or more of the following features. In some embodiments, the wheel can include a plurality of spikes projecting from the outer major surface of one or more of the plates of the outer circumferential portion. In some such embodiments, the spikes can be located adjacent to the first and second edges of the one or more plates of the outer circumferential portion. In some embodiments, the circumferential portion can include eight flat rectangular plates connected together to form an octagon. In some embodiments, the plurality of flat rectangular plates can comprise a single sheet bent to form the rectangular plates. In some such embodiments, the sheet can have two ends connected together to form the regular polygon.

In a second aspect, the present invention provides a regular polygonal wheel for use in an irrigation system. The wheel can include a central hub comprising a central plate having a central bore and a hub support adjoined to and perpendicular to the central plate. The wheel can include an outer circumferential portion, which includes an outer body and an outer body support. The outer body can have a plurality of flat rectangular plates, which have inner and outer opposed major surfaces, along with first and second opposed edges and third and fourth opposed edges. The first edge can be connected to the second edge of another of the plurality of plates. The outer body support can be adjoined to and perpendicular to the inner major surface of the outer body. The wheel can include a plurality of spokes, which comprise a spoke body and a spoke support. The spoke body can connect the central plate to the outer body. The spoke support can be adjoined to and perpendicular to the spoke body and can connect the hub support to the outer body support.

In some embodiments, the wheel includes a plurality of radial projections extending radially outward from the outer major surface of one or more of the rectangular plates of the outer circumferential portion. The radial projections can include V-shaped projections. The V-shaped projections can have first and second rectangular sides with inner edges connected to the outer major surface of the corresponding plate and outer edges that connect to one another to form a V. In some embodiments, each V-shaped projection extends across the plate from the third edge to the fourth edge. In some embodiments, the wheel can include a plurality of spikes projecting from the outer major surface of one or more plates of the outer circumferential portion. In some such embodiments, the spikes are located adjacent to where the first edge of one plate connects to the second edge of another plate.

In a third aspect, the invention provides a method of irrigating a field. The method can include providing an agricultural irrigation system to the field. The irrigation system can have a plurality of polygonal wheels. Each wheel can include a central hub defining a central bore mated with a wheel stud of the irrigation system. Each wheel can include an outer circumferential portion comprising a plurality of flat rectangular plates connected together to form a rectangular polygon. Each plate can have the attributes of the plates discussed in connection with the first and/or second aspects of the present invention. Each wheel can include a plurality of spokes connecting the central hub and the outer circumferential portion. The method can include supplying water to the field through the irrigation system. The method can include moving the irrigation system to a new location in the field by rolling the wheels to move them forward in a stepwise manner. An example of a stepwise manner involves each wheel resting on one rectangular plate, rolling forward over an adjacent corner edge, and resting on an adjacent rectangular plate.

Methods according to the third aspect of the present invention can include one or more of the following features. In some embodiments, the polygonal wheels include a plurality of radial projections extending radially outward from the outer major surface of one or more of the plates of the outer circumferential portion. In some such embodiments, the radial projections can contact the field when the irrigation system is moving to the new location in the field. In some embodiments, each radial projection comprises a V-shaped projection. The V-shaped projection can have first and second rectangular sides with inner edges connected to the outer major surface of the corresponding plate and outer edges that connect with one another to form a V. The V-shaped projection can be oriented in parallel with the first and second edges of its corresponding plate. In some embodiments, the polygonal wheels can each include a plurality of spikes projecting from the outer major surface of one or more of the plates of the outer circumferential portion. In some such embodiments, the spikes can be located adjacent to the first and second edges of the one or more plates of the outer circumferential portion.

### BRIEF DESCRIPTION OF THE DRAWINGS

FIG. 1 is a side view of a wheel according to embodiments of the invention;

FIG. 2 is a cross-sectional view of the wheel of FIG. 1;

FIG. 3 is a side view of a wheel according to embodiments of the invention;

FIG. 4 is a side view of wheel according to embodiments of the invention;

FIG. 5 is a perspective view of a wheel according to embodiments of the invention.

FIG. 6 is a wheel according to embodiments of the invention in use with an irrigation system.

FIG. 7 is a perspective view of the wheel of FIG. 6.

### DETAILED DESCRIPTION

The following detailed description is exemplary in nature and is not intended to limit the scope, applicability, or configuration of the invention in any way. Rather, the following description provides practical illustrations for implementing exemplary embodiments of the present invention. Examples of constructions, materials, dimensions, and manufacturing processes are provided for selected elements, and all other elements employ that which is known to those of skill in the field of the invention. Those skilled in the art will recognize that many of the examples provided have suitable alternatives that can be utilized.

Embodiments of the invention include wheels having a regular polygonal shape. In some embodiments, the wheels also include a plurality of radially extending projections extending from the support surface of the wheel. Such wheels are particularly useful in ground which is soft or muddy and for the transportation of heavy machinery, such as crop irrigation systems. Such wheels may also be useful for transportation of equipment or machinery in muddy or soft ground, such as lighter weight tractors or other applications in which flotation is desired. The polygonal shape and the radial projections allow the wheel to move forward in a step wise motion that resists spinning in place, thus providing improved traction and reducing the formation of ruts.

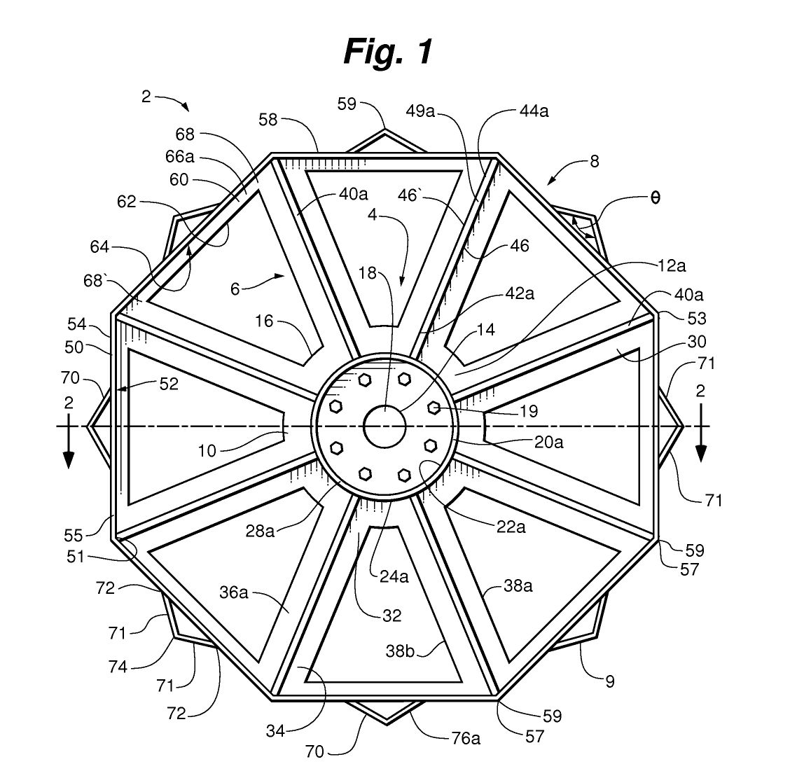

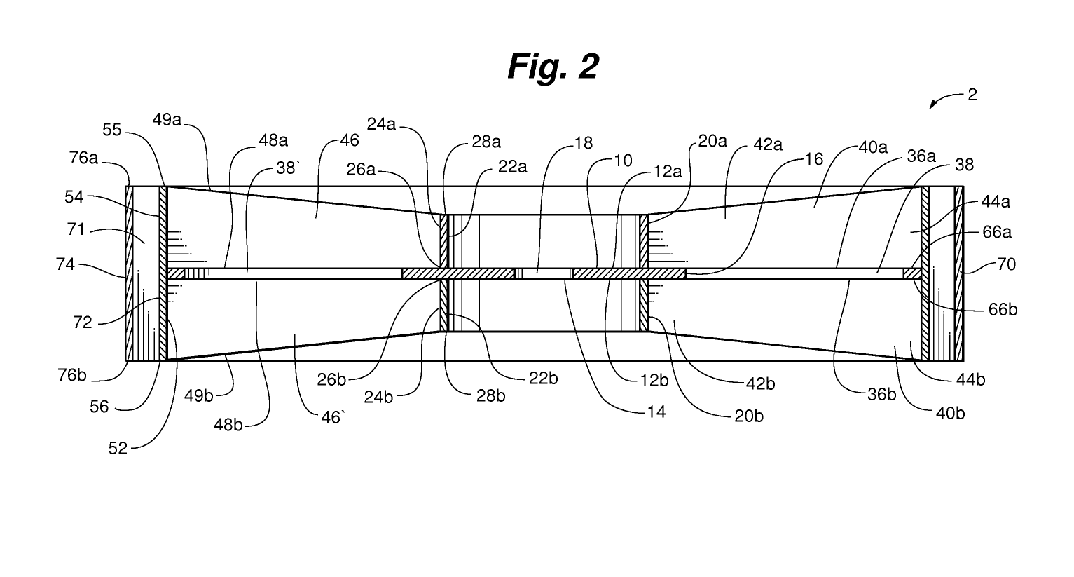

An example of a wheel according to embodiments of the invention is shown in FIGS. 1 and 2, where FIG. 2 is a cross-sectional view through the dashed lines of FIG. 1. The wheel 2 includes a hub 4, spokes 6 and an outer circumferential portion 8. The outer circumferential portion 8 forms the outer surface of the wheel and is the portion of the wheel 2 which rests upon or contacts a surface such as the ground. As can be seen, the outer circumferential portion is polygonal in shape. The wheel 2 further includes a plurality of radial projections 9 extending radially outward from the outer circumferential portion 8.

The hub 4 is located at the center of the wheel 2 and forms the connection point to an axle (not shown) which drives the wheel to power its rotation, such as through a gear box. The hub 4 includes a central plate 10 and a hub support 20a, 20b. The central plate 10 is located in the central plane of the wheel 2. The central plane is the plane in which the wheel rotates, perpendicular to the axis of rotation, which bisects the wheel into two equal and mirror image halves. In the embodiment shown in FIG. 1, the central plate 10 forms the center of the wheel. The central plate 10 may have a circular shape as shown, or alternatively may be polygonal, such as having the same number of sides as the outer circumferential portion, or may have any other similar shape. The central plate 10 has a first flat surface 12a and an opposing second flat surface 12b, an inner edge 14 and an outer edge 16 around its circumference. The inner edge 14 surrounds a centrally located bore 18 which may be configured to mate with a wheel stud, such as in an agricultural irrigation system, extending through the central plate 10. The central plate 10 may also include a plurality of peripherally located apertures 19 located radially outward from the bore 18 and also extending through the central plate 10. In the embodiment shown, there are 8 peripheral apertures 19 which may be also used for connection of the wheel 2 to the machinery, such as by the insertion of bolts through the peripheral apertures 19 and into the machinery.

The hub 4 may also optionally include a first hub support 20a and a second hub support 20b located on opposing sides of the wheel 2. The hub supports 20a, 20b each form a circular projecting band which encircles the bore 18 and extends laterally outward from the central plate 10. Each hub support 20a, 20b includes an inner surface 22a, 22b, an outer surface 24a, 24b, an inside edge 26a, 26b and an outside edge 28a, 28b. The inside edge 26a connects the first hub support 20a to the first surface 12a of the central plate 10. Likewise the inside edge 26b of the second hub support 20b connects it to the second surface 12b of the central plate 10. The outer surface 24a, 24b of each hub support 20a, 20b abuts and supports the spoke supports 40a, 40b as described later in this application.

The hub supports 20a, 20b as shown in FIGS. 1 and 2 are circular, having a concave inner surface 22a, 22b and a convex outer surface 24a, 24b. In alternative embodiments, the hub supports 20a, 20b may have a polygonal shape. In some embodiments, the polygonal hub supports may have the same number of sides as the outer circumferential portion of the wheel. In such embodiments, the sides of the polygonal hub support may be parallel to the rectangular plates of the outer circumferential portion 8.

In the embodiment shown in FIGS. 1 and 2, the hub supports 20a, 20b are located radially outward from the peripheral apertures 19 and radially inward from the outer edge 16 of the central plate 10. In alternative embodiments, the hub supports 20a, 20b may extend outward from the first and second surfaces 12a, 12b of the central plate 10 at any location, such as at the inner edge 14, at the outer edge 16, or at any location between the inner and outer edges 14, 16.

The wheel 2 further includes a plurality of spokes 6 which extend radially outward from the hub 4 to connect the hub 4 to the outer circumferential portion 8. In the embodiment shown in FIGS. 1 and 2, the number of spokes 6 is equal to the number of rectangular plates of the polygonal outer circumferential portion 8. In the embodiment shown in FIGS. 1 and 2, the outer circumferential portion 8 is octagonal and there are eight spokes 6 connecting the hub 4 to the outer circumferential portion 8. However, in alternative embodiments, the outer circumferential portion 8 may have from five to ten rectangular plates, and the wheel 2 may have the corresponding number of spokes 6.

Each spoke 6 includes a spoke body 30 and may also include a first and second spoke support 40a, 40b. The spoke body 30 is a longitudinal structure which extends radially outward from the hub 4 to the outer circumferential portion 8 of the wheel. The spoke body 30 includes a proximal end 32 and a distal end 34. The proximal end 32 is attached to or contiguous with the hub 4 at the outer edge 16 of the central plate 10 and lies in the central plane along with the central plate 10. The distal end 34 of each spoke body 30 is attached to the inner major surface 52 of each rectangular plate.

In the embodiment shown in FIGS. 1 and 2, the spoke bodies 30 are flat strips, having opposing first and second flat surfaces 36a and 36b. The first flat surface 36a is seen in FIG. 1, while the opposing second flat surface 36b is located on the opposite side of the spoke body 30. The spoke body 30 further includes two longitudinal edges 38a and 38b which extend from the proximal end 32 to the distal end 34. In the embodiment shown in FIG. 1, the longitudinal edges 38a, 38b are parallel to each other, such that the spoke body 30 is rectangular in shape. Alternatively, the longitudinal edges 38a, 38b could converge or diverge as they extend radially outward, giving the spoke body the shape of a parallelogram. In alternative embodiments, the spoke bodies may be rod shaped, having a circular cross-section and no flat surfaces.

One or more of the spokes 6 may also includes spoke supports 40a, 40b on either one or on both surfaces 36a, 36b of the spoke bodies 30. In the embodiment shown, each spoke 6 includes a pair of spoke supports 40a, 40b which are flat, longitudinally extending strips located on opposing surfaces 36a, 36b of the spoke body. The spoke supports 40a, 40b are longitudinal members that project from the spoke body 30 on opposing sides of the spoke body 30, perpendicular to the central plane, and extend radially outward along the length of the spoke body 30. Each spoke support 40a, 40b includes a proximal end 42a, 42b and a distal end 44a, 44b, a pair of opposing surfaces 46, 46′, an inside edge 48a, 48b and an outside edge 49a, 49b. The inside edge 48a, 48b abuts and connects the spoke support 40a, 40b to the spoke body 30 along the length of the spoke body 30 and extends from the proximal end 32 to the distal end 34 of the spoke body. The inside edge 48a of the first spoke support 40a abuts the first surface 36a of the spoke body 30, while the inside edge 48b of the second spoke support 40b abuts the second surface 36b of the spoke body. In this way, each spoke support 40a, 40b extends along the length of each spoke body 30, giving additional strength to the spoke body 30.

The proximal end 42a, 42b of each spoke support 40a, 40b is attached to the outer surface 24a, 24b of the corresponding hub support 20a, 20b on each side of the wheel 2. The distal end 44a, 44b of each spoke support 40a, 40b is attached to the inner major surface 52 of the outer circumferential portion 8. The spoke support 40 therefore strengthens the spoke body 30 and also transmits weight from the outer circumferential portion 8 to the hub supports 20a, 20b, which provide a base of support for the spoke supports 40a, 40b.

As shown in FIG. 2, the width of each spoke support 40a, 40b at their proximal ends 42a, 42b is equal to the width of each corresponding hub support 20a, 20b, such that the proximal ends 42a, 42b of the spoke supports 40a, 40b extends from the inside edge 26a, 26b to the outside edge 28a, 28b of the hub supports 20a, 20b. Likewise, the width of the distal ends 44a, 44b of the spoke supports 40a, 40b is equal to the distance from each surface 36a, 36b of the spoke body 30 to the third or fourth opposed edges 56a, 56b of the outer circumferential portion 8 (being almost one half the width of the outer circumferential portion 8). However, because the width of about one half of the outer circumferential portion 8 is greater than that of the hub supports 20a, 20b, the inside edges 48a, 48b and outside edge 49a, 49b of the of the spoke supports 40a, 40b diverge from each other as they extend radially outward, such that the width of the proximal ends 42a, 42b of the spoke supports 40a, 40b is less than the width of the distal ends 44a, 44b of the spoke support 40. In the embodiment shown, the inside edges 48a, 48b are parallel to the central plane while the outside edges 49a, 49b extend laterally away from the central plane as they extend radially outward.

In alternative embodiments, the inside and outside edges of the spoke supports may be parallel to each other and to the central plane. For example, the width of the central hub plus the thickness of the central plate may be equal to the width of the outer circumferential portion 8. Alternatively, the width of the distal ends of the spoke supports may be less than about half of the width of the outer circumferential portion, such that the distal ends of the spoke supports would not extend all the way from the surface of the spoke body to the third or fourth edge of the outer circumferential portion but rather would leaves a gap between the distal end of the outside edge of the spoke support and the third or fourth edge of the outer circumferential portion. Many additional spoke configurations are possible, such as rods (e.g., radially extending), bars, ribs, or other lengths of material to maintain the outer circumferential portion 8 in a generally fixed spatial relationship with the hub 4.

The outer circumferential portion 8 of the wheel 2 forms the outermost surface of the wheel 2 and forms the weight bearing surface of the wheel 2 which abuts the ground, or contacts a surface, such as the wheel 2 turns. The outer circumferential portion 8 includes an outer body 50 and may optionally include an outer body support 60.

The outer body 50 is an annular structure comprised of a plurality of interconnected flat rectangular plates 58. Each plate 58 has an inner major surface 52 and an opposing outer major surface 54, first and second opposing edges 57, 59 and third and fourth opposing edges 55, 56. Unlike typical round wheels, the inner and outer major surfaces 52, 54 are not convex and concave respectively. Rather, each surface 52, 54 is flat. The dimensions of each of the plates 58 are equal to each other, such that together they form an annular structure which is shaped like a regular polygon. The first edge is connected to the second edge of another plate 58 along the length of the edge to form an interior angle. The interior angle, multiplied by the number of plates, is equal to 360 degrees. The plane of each inner and outer major surface 52, 54 is perpendicular to the central plane and to the wheel's radius and is parallel to the axis of rotation of the wheel 2.

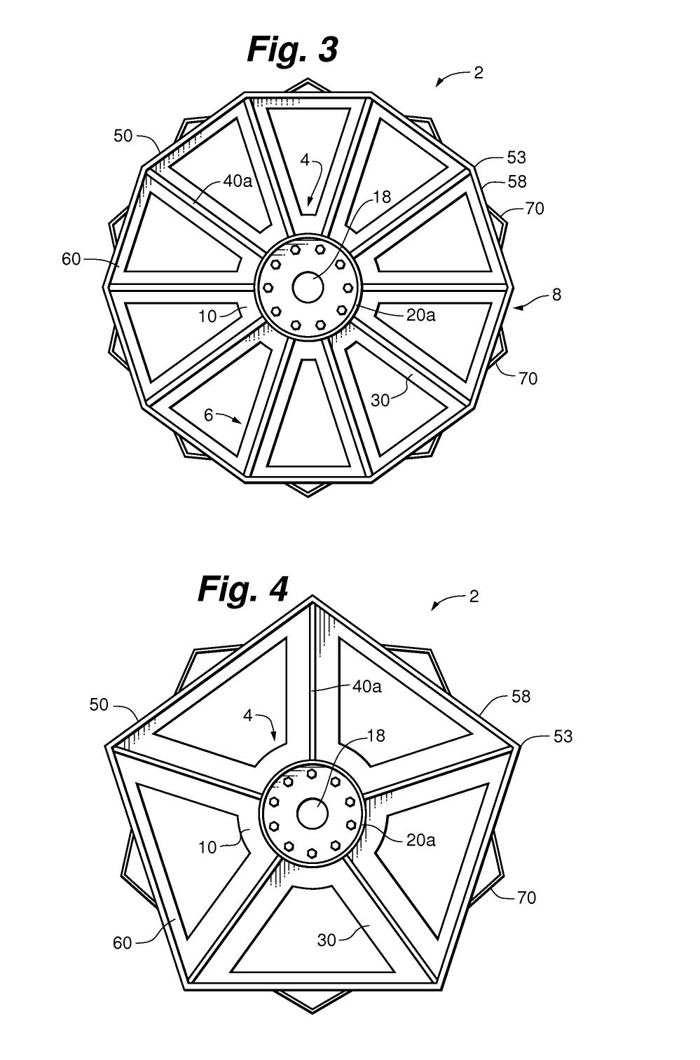

The outer body 50 may have between five and ten rectangular plates 58 and may have an equal number of coves 51 having interior angles. In the embodiment shown in FIGS. 1 and 2, the outer body 50 includes eight rectangular plate 58. An example of an embodiment having five sides is shown in FIG. 3, while an example of an embodiment having ten sides is shown in FIG. 4. Many structural components and/or functional characteristics of the wheel can be similar irrespective of the number of sides.

The surface area of each rectangular plate 58 may be increased by having a width (the length of the first and second edges 57, 59) which is greater than that of a standard wheel. By increasing the surface area of the rectangular plates 58 of the outer body 50 and by making them flat, the weight of the machinery being transported by the wheel 2 is distributed over a greater area than a typical round, narrow wheel, where only a portion of the wheel rests on the grounds and supports all of the weight. By increasing the surface area, the outer circumferential portion 8 is better supported by the ground and is less likely to sink into the mud and form ruts. Rather, the distributed weight can rest atop the ground without sinking into mud, thereby sinking less than a round tire would sink.

The outer circumferential portion 8 may also include a plurality of outer body supports 60. The outer body supports 60 have longitudinal structures including an inner edge 62 and an outer edge 64 extending along the length of the outer body support 60. They also include first and second surfaces 66a, 66b which oppose each other and first and second ends 68, 68′ which adjoin each other and the spoke 6 at the interior angles of the outer body 50. The outer body supports 60 are located in the central plane of the wheel 2 and are attached in series to each inner major surface 52 of the outer body 50. Each outer body support 60 projects radially inward and perpendicularly from each inner major surface 52 of the outer body 50, to which it is attached along its outer edge 64, while the inner edge 62 is exposed.

In the embodiment shown in FIGS. 1 and 2, the distal ends 34, 44a, 44b of the spoke bodies 30 and spoke supports 40a, 40b attach to the outer body 50 and outer body support 60 at an interior angle. In such an embodiment, the distal end 34 of the spoke body 30 is pointed outward into a V-shaped angle, with an angle equal to that of the interior angle. Alternatively, the distal ends 34, 44a, 44b of the spoke bodies 30 and spoke supports 40a, 40b could attach to the outer body 50 and outer body support 60 at the inner major surface 52 of the rectangular plate 58 such as at or near the center of the plate 58. In such an embodiment, the distal end of the spoke body 30 may form a single flat edge. In many embodiments, the structure of the wheel 2 that is interior to the outer circumferential portion can provide support and strength that significantly benefits agricultural irrigation systems, which are by nature larger and heavier than many other structures that have wheels.

The wheel 2 may optionally include a plurality of radial projections 9 which extend radially outward from the outer major surface 54 of the plates 58. The use of such radial projections 9 can provide additional traction to the wheel 2, to further prevent the wheel 2 from slipping or spinning. In some embodiments, one or more of the radial projections 9 are V-shaped projections 70 such as those shown in FIG. 1. In the embodiment shown in FIG. 1, a plurality of angular projections 70 extend from the center of the outer major surface 54 of each plate 58 and extend from the third edge 55 to the opposing fourth edge 56. Alternatively, the angular projections may not extend fully to the third and fourth edges 55, 56, or may extend laterally beyond the third and fourth edges 55, 56. The angular projections 70 are formed of first and second rectangular sides 71 each having an inner edge 72 connected to the outer major surface 54 of the corresponding plate 58 and an outer edge 74 that connect with one another to form a V. The edges 72, 74 of the V-shaped projection are oriented parallel to the first and second edges 57, 59 and to the axis of rotation. The sides 71 form an angle θ of less than 180 degrees, such that the angular projection projects out from the rectangular plate 58. In some embodiments, the angle θ is between about 30 and about 60 degrees. In some embodiments, the angle θ is between about 40 and about 50 degrees. In preferred embodiments, the angle θ is about 45 degrees. Often, the V-shaped projections 70 comprise a single sheet of metal bent to form the first and second rectangular sides 71.

The angle θ formed by the angular projection 70 may be sharper than that of the interior angle of the plates 58 at the coves 51. For example, the angle θ may be 90 degrees or less, such as between 10 degrees and 90 degrees. By having a sharper angle than the interior angle of the outer body 50, the angular projections 70 may provide an added element of traction which is greater than that of the interior angle. For example, the angle of the polygonal wheel 2 at the interior angle will be better able to dig into the earth than a round wheel, but spinning is still possible. Therefore, by providing an additional element of traction in the form of a radial projection 9, having, in some embodiments, a sharper outwardly projecting angle, spinning may be further reduced or avoided altogether.

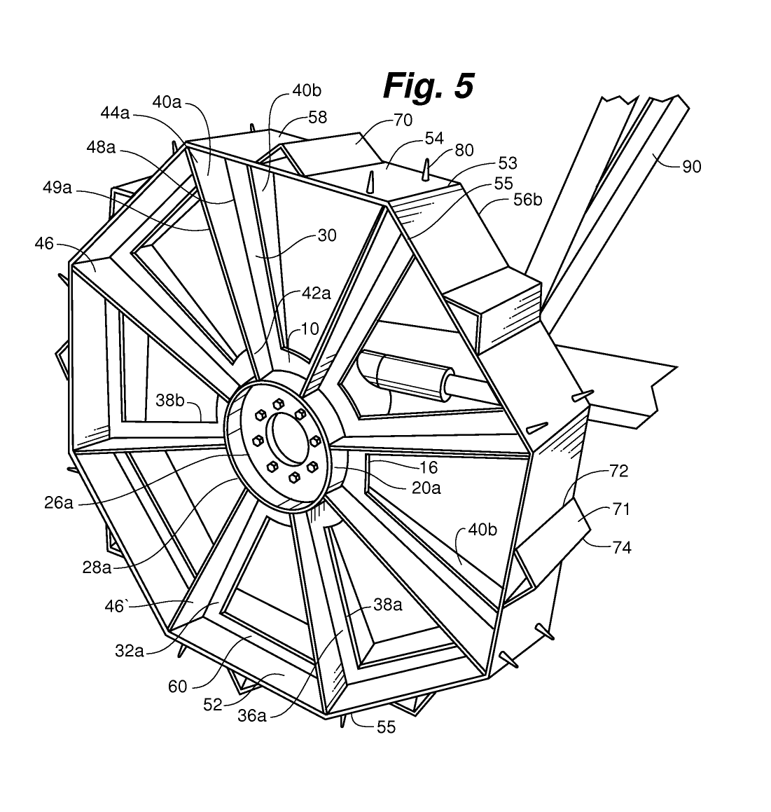

In alternative embodiments, the one or more radial projections 9 may be a spike 80 or similar structure, such as the embodiment shown in FIG. 5. One or more spikes could be provided on the outer major surface 54 of the outer body 50. For example, a single spike 80 could be provided at the center of rectangular plate 58, in the location of the angular projection as shown. Alternatively, a plurality of spikes 80 such as a row of spikes could be provided in this location, extending from third edge 55 to fourth edge 56. The spikes 80 may be permanently attached to the outer major surface 54 of the outer body 50, such as by welding. Alternatively, the spikes 80 may be optionally attached or removed. For example, the outer circumferential portion may include apertures through which a bolt may be placed to secure a spike when desired.

In the embodiment shown in FIG. 5, one or more spikes 80 may be optionally provided on the outer major surface 54 of the plates 58, such as adjacent to the third or fourth edge 55, 56 and adjacent to the first and second edge 57, 59. The spikes 80 may be secured to the outer major surface 54 of the plate 58 by welding them into place, by inserting them though apertures in the outer body 50 and then welding them into place, or by any other suitable method. In the embodiment shown in FIG. 5, the wheel 2 includes radial projections 9 including both angular projections 70 and spikes 80, to provide additional traction.

In operation, the wheel 2 rolls forward in a relatively smooth manner, with only a slight rise and fall. In most cases, the wheel 2 rolls relatively slowly, as irrigation systems do not travel very fast. The rise and fall of the wheel 2 is reduced because corner 53 sinks somewhat into the soft muddy ground. Rotation may begin with a rectangular plate 58 of the outer circumferential portion 8 of the wheel 2 resting on and parallel to the ground, for example. In this position, the weight is distributed over the surface of the plate 58 and therefore little or no sinking or rut formation occurs. As the wheel 2 turns and rolls forward, the forward oriented corner 53 will begin to push into the ground. The plate 58 of the wheel 2 will rise into the air, rotating and pivoting upward above the forward corner 53 as it digs into the ground. Eventually, as the rotation continues, the next adjacent plate 58 will come to rest flat on the ground, with the corner 53 which had been the forward oriented corner edge now forming a back oriented corner 53. In this way, the wheel moves forward in a step like motion, with only the corners 53 digging into the earth at intervals (steps) equal to the length of the plate (the distance between adjacent corners 53). The wheel will then rotate above the next adjacent forward corner 53, with the plate 58 rising again. The space between each corner 53 which forms the plate 58 will not dig into the earth but rather will rest flat on the earth, leaving a distance of undisturbed ground. As such, the polygonal shape allows the wheel 2 to move forward by steps, with only the corners edges 59 digging into the ground, rather than the entire circumference of the wheel forming deep lines of ruts, as occurs with traditional round wheels, and with better traction than traditional round wheels. In preferred embodiments, the wheel 2 itself has no components that move relative to one another, meaning that there is less opportunity for the wheel to break.

As the wheel 2 rotates forward, traction is provided by the corner 53, which digs into the earth to grip. As described above, in some embodiments, the wheel further includes radial projections 9 extending from the outer major surfaces 54 to provide additional fraction and further prevent spinning of the wheel 2 and the formation of ruts. These radial projections 9 may be particularly helpful, since without them only the forward oriented corner 53 is able to provide traction as the wheel 2 advances. The radial projections 9 become inserted into the earth and then pulled out of the earth as the wheel 2 rolls forward. However, because or their angle and the depth of their insertion into the ground, they are resistant to sliding horizontally through the earth as would happen if the wheel 2 were to spin in place. When the wheel 2 includes angular projections 70, the entire length of the outer edge 74 provides resistance to the wheel 2 sliding through the earth. The radial projections 9 therefore provide an additional traction point to dig into the earth to prevent the wheel from spinning in place.

The wheel 2 may be constructed of a sheet of metal, such as a single ½ inch thick sheet of metal, or a ¼ inch thick sheet of metal folded upon itself to form a ½ inch sheet. The construction of the wheel 2 is therefore simple and low cost. In some embodiments, some or all of the wheel can be galvanized. The single sheet of metal can be bent to form a regular polygon with each side of the regular polygon constituting a rectangular plate. The single sheet can have two longer edges and two shorter edges, and the two shorter edges can be connected to one another (e.g., via welding) to form the regular polygon. In some embodiments, two sheets of metal can be bent into half of the regular polygon (e.g., having four of eight sides), and the two bent structures can be joined together to form the regular polygon (e.g., with two welds). Many construction methods are possible. Also, the wheel 2 is free of moving parts and avoids the need for a rubber tire (which eventually requires changing or repairing), making the wheel simple and requiring less maintenance or repairs.

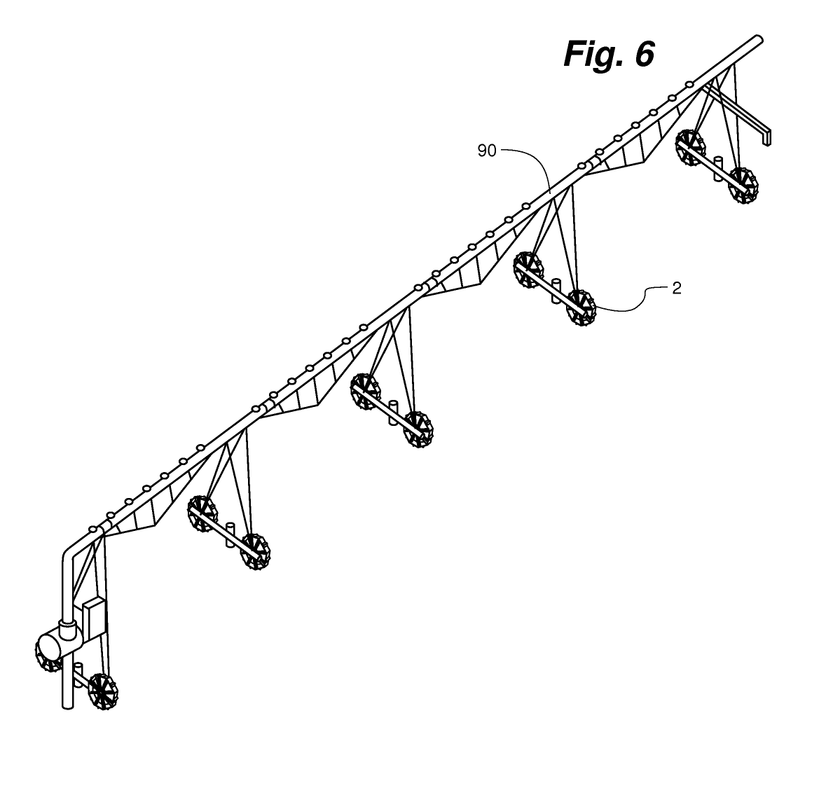

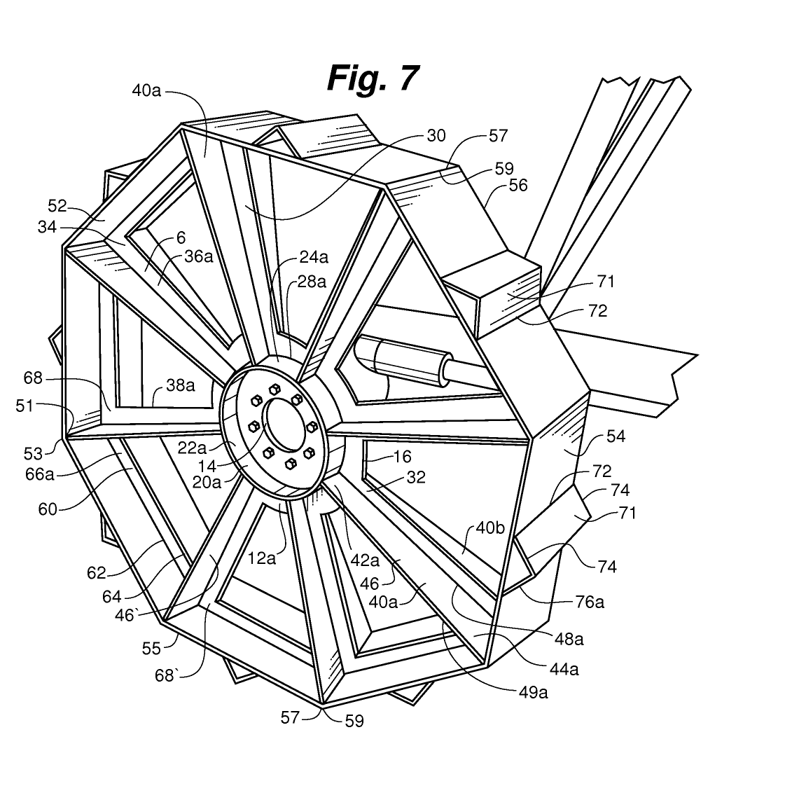

FIGS. 6 and 7 show an example of an embodiment of the invention in use with an irrigation system 90. The polygonal wheels 2 support the irrigation system 90 on the ground in the field. Water is supplied to the field through the irrigation system 90 in one location. After an adequate amount of water has been provided to the field, the irrigation system 90 is moved to a new location by advancing it on the wheels 2. As described above, the wheels 2 advance in a step-wise fashion, minimizing damage to the field and any crops which may be growing there. Once it has been moved to the new location, the irrigation system 90 may be used again to provide water at the new location. The irrigation system 90 shown in the FIG. 6 is a center-pivot irrigation system, however the polygonal wheels 2 according to embodiments of the invention may be used with other irrigation systems 90 such as a lateral irrigation system. Likewise, any embodiments of the polygonal wheel 2 may be used with any type of mobile irrigation systems.

In the foregoing detailed description, the invention has been described with reference to specific embodiments. However, it may be appreciated that various modifications and changes can be made without departing from the scope of the invention as set forth in the appended claims. Thus, some of the features of preferred embodiments described herein are not necessarily included in preferred embodiments of the invention which are intended for alternative uses.

1. A regular polygonal wheel for use in an agricultural irrigation system, the wheel comprising:
(a) a central hub defining a central bore configured to mate with a wheel stud of the agricultural irrigation system;
(b) an outer circumferential portion configured to contact a surface on which the wheel is rolling, the circumferential portion comprising a plurality of flat rectangular plates connected together to form a regular polygon, each plate:
(i) having inner and outer opposed major surfaces, along with first and second opposed edges and third and fourth opposed edges,
(ii) being oriented such that its inner and outer major surfaces are perpendicular to the wheel's radius,
(iii) having its first edge connected to the second edge of another of the plurality of plates to form an interior angle, and
(iv) having the first edge of yet another of the plurality of plates connected to its second edge to form the interior angle, wherein the interior angle multiplied by the number of plates equals 360 degrees; and
(c) a plurality of spokes connecting the central hub and the outer circumferential portion.

2. The wheel of claim 1 further comprising a plurality of radial projections extending radially outward from the outer major surface of one or more of the plates of the outer circumferential portion, the radial projections being configured to contact the surface on which the wheel is rolling.

3. The wheel of claim 2 wherein each radial projection comprises a V-shaped projection having first and second rectangular sides with inner edges connected to the outer major surface of the corresponding plate and outer edges that connect with one another to form a V, the V-shaped projection being oriented in parallel with the first and second edges of its corresponding plate.

4. The wheel of claim 3 wherein each V-shaped projection extends from the third edge to the fourth edge of the corresponding plate.

5. The wheel of claim 3 wherein the first and second rectangular sides form an interior projection angle which is less than the interior angle.

6. The wheel of claim 1 further comprising a plurality of spikes projecting from the outer major surface of one or more of the plates of the outer circumferential portion.

7. The wheel of claim 6 wherein the spikes are located adjacent to the first and second edges of the one or more plates of the outer circumferential portion.

8. The wheel of claim 1 wherein the circumferential portion comprises eight flat rectangular plates connected together to form an octagon.

9. The wheel of claim 1 wherein the plurality of flat rectangular plates comprise a single sheet bent to form the rectangular plates, the sheet having two ends connected together to form the regular polygon.

10. A regular polygonal wheel for use in an irrigation system, wheel comprising:
a central hub comprising a central plate having a central bore and a hub support adjoined to and perpendicular to the central plate;
an outer circumferential portion comprising an outer body and an outer body support, the outer body having a plurality of flat rectangular plates having inner and outer opposed major surfaces, along with first and second opposed edges and third and fourth opposed edges, the first edge connected to the second edge of another of the plurality of plates, and the outer body support adjoined to and perpendicular to the inner major surface of the outer body; and
a plurality of spokes comprising a spoke body and a spoke support, wherein the spoke body connects the central plate to the outer body and wherein the spoke support is adjoined to and perpendicular to the spoke body and connects the hub support to the outer body support.

11. The wheel of claim 10 further comprising a plurality of radial projections extending radially outward from the outer major surface of one or more of the rectangular plates of the outer circumferential portion.

12. The wheel of claim 11 wherein the radial projections comprise V-shaped projections having first and second rectangular sides with inner edges connected to the outer major surface of the corresponding plate and outer edges that connect to one another to form a V.

13. The wheel of claim 12 wherein each V-shaped projection extends across the plate from the third edge to the fourth edge.

14. The wheel of claim 12 further comprising a plurality of spikes projecting from the outer major surface of one or more plates of the outer circumferential portion.

15. The wheel of claim 14 wherein the spikes are located adjacent to where the first edge of one plate connects to the second edge of another plate.

16. A method of irrigating a field comprising:
providing an agricultural irrigation system to the field, the irrigation system having a plurality of polygonal wheels, each polygonal wheel comprising:
(a) a central hub defining a central bore mated with a wheel stud of the irrigation system;
(b) an outer circumferential portion comprising a plurality of flat rectangular plates connected together to form a rectangular polygon, each plate:
(i) having inner and outer opposed major surfaces, along with first and second opposed edges and third and fourth opposed edges,
(ii) being oriented such that its inner and outer major surfaces are perpendicular to the wheel's radius,
(iii) having its first edge connected to the second edge of another of the plurality of plates to form an interior angle, and
(iv) having the first edge of yet another of the plurality of plates connected to its second edge to form the interior angle, wherein the interior angle multiplied by the number of plates equals 360 degrees; and
(c) a plurality of spokes connecting the central hub and the outer circumferential portion;
supplying water to the field through the irrigation system;
moving the irrigation system to a new location in the field by rolling the wheels to move them forward in a stepwise manner such that each wheel rests on one rectangular plate, rolls forward over an adjacent corner edge, and rests on an adjacent rectangular plate.

17. The method of claim 16 wherein the polygonal wheels each further comprise a plurality of radial projections extending radially outward from the outer major surface of one or more of the plates of the outer circumferential portion, the radial projections contacting the field when the irrigation system is moving to the new location in the field.

18. The method of claim 16 wherein each radial projection comprises a V-shaped projection having first and second rectangular sides with inner edges connected to the outer major surface of the corresponding plate and outer edges that connect with one another to form a V, the V-shaped projection being oriented in parallel with the first and second edges of its corresponding plate.

19. The method of claim 16 wherein the polygonal wheels each further comprise a plurality of spikes projecting from the outer major surface of one or more of the plates of the outer circumferential portion.

20. The method of claim 19 wherein the spikes are located adjacent to the first and second edges of the one or more plates of the outer circumferential portion.
